(19) United States
(12) Patent Application Publication
(10) Pub. No.: US 2024/0188531 A1
(43) Pub. Date: Jun. 13, 2024

(54) PET SHEET AND KIT

(71) Applicant: Unicharm Corporation, Ehime (JP)

(72) Inventors: Mami Yamashita, Kanonji-shi (JP); Hideyuki Onishi, Kanonji-shi (JP); Daisuke Komatsubara, Kanonji-shi (JP)

(73) Assignee: Unicharm Corporation, Ehime (JP)

(21) Appl. No.: 18/444,915

(22) Filed: Feb. 19, 2024

Related U.S. Application Data
(63) Continuation of application No. PCT/JP22/31209, filed on Aug. 18, 2022.

(30) Foreign Application Priority Data
Aug. 19, 2021 (JP) 2021-134014

(51) Int. Cl. A01K 1/01

(52) U.S. Cl. CPC A01K 1/0107

(57) ABSTRACT

A pet sheet includes a liquid-permeable top sheet, a liquid-impermeable back sheet, and an absorbent body disposed between the liquid-permeable top sheet and the liquid-impermeable back sheet. The liquid-impermeable back sheet has an adhesive surface. The liquid-permeable top sheet, the liquid-impermeable back sheet, and the absorbent body are disposed such that a light transmittance is 60% or less. The pet sheet is configured to be overlaid on an animal excrement disposal sheet.

### CROSS-REFERENCE TO RELATED APPLICATIONS

The present application claims priority to Japanese Patent Application No. 2021-134014, filed Aug. 19, 2021. The contents of this application are incorporated herein by reference in their entirety.

### BACKGROUND

### Technical Field

The present invention relates to a pet sheet to be overlaid on an animal excrement disposal sheet in use; and a kit including the pet sheet and the animal excrement disposal sheet.

### Description of the Related Art

As an animal excrement disposal sheet for disposing excrement excreted by pets such as a dog, an animal excrement disposal sheet provided with a liquid-permeable top sheet, a liquid-impermeable back sheet, and an absorbent body positioned between these sheets is known (see, for example, Patent Literature 1).

Various animal excrement disposal sheets have been proposed. For example, Patent Literature 2 describes a pet sheet in which an adhesive layer is formed on a back sheet. It is described that since the adhesive layer enables the pet sheet to adhere to a surface to which the pet sheet abuts, it is more likely to prevent a movement of the pet sheet in use and to hold the form of the pet sheet when excrement is enclosed after use.

Patent Literature 3 describes a urine-absorbing sheet for pet animals, the urine-absorbing sheet being formed by interposing a urine absorbent body between a urine-permeable top sheet and a urine-impermeable back sheet, in which the top sheet has a fastening means capable of detaching a second urine-absorbing sheet at a necessary site on the upper surface of the urine-absorbing sheet. It is described that in the urine-absorbing sheet, the second urine-absorbing sheet is fixed by the fastening means, making it possible to form a two-layer structure in a central part which is frequently used, and the second urine-absorbing sheet is peeled off and replaced with a new second urine-absorbing sheet when urine reaches a saturation amount or the second urine-absorbing sheet is damaged.

### PATENT LITERATURE

Patent Literature 1: Japanese Patent Publication No. 2003-92940
Patent Literature 2: Japanese Registered Utility Model No. 3054884
Patent Literature 3: Japanese Patent Publication No. H8-317740

Pets tend to excrete on animal excrement disposal sheets while avoiding urine traces on the sheets. Therefore, in order for the pets to avoid urine traces, the pets urinate in abnormal urination postures although the bodies are on the sheets, which thus causes urination outside the animal excrement disposal sheets. In addition, depending on pets, pets may excrete outside animal excrement disposal sheets without riding over the animal excrement disposal sheets when the pets feel a discomfort from urine traces and the like on the animal excrement disposal sheets.

### SUMMARY

One or more embodiments provide a pet sheet to be overlaid in use, which makes it possible for an owner to simply prepare a clean excrement disposal sheet, and with which a pet is less likely to feel a discomfort from urine traces and the like; and a kit including the pet sheet.

One or more embodiments include the following aspects.

(1) An aspect of one or more embodiments is a pet sheet to be overlaid on an animal excrement disposal sheet in use, the pet sheet comprising: a liquid-permeable top sheet; a liquid-impermeable back sheet; and an absorbent body arranged between these sheets, wherein the back sheet has an adhesive surface, and the top sheet, the back sheet, and the absorbent body are arranged so that a light transmittance is 60% or less.

(2) In the pet sheet according to (1), the top sheet, the back sheet, and the absorbent body may be arranged so that a thickness of a product is greater than 0.2 mm and 10 mm or less.

(3) In the pet sheet according to (1) or (2), the top sheet, the back sheet, and the absorbent body may be arranged so that an area of a region where the absorbent body is present is 80% or less of an entire surface of the pet sheet in a plan view.

(4) In the pet sheet according to any one of (1) to (3), the back sheet and the absorbent body may be arranged so that a difference between a thickness of a region where the absorbent body is present and a thickness of a flap region where the absorbent body is not present is 0.3 mm or more and 5 mm or less.

(5) In the pet sheet according to any one of (1) to (4), a size of a product may be 1,500 cm² or less.

(6) In the pet sheet according to any one of (1) to (5), a WC value obtained by a KES compression characteristic tester may be 0.03 to 0.35, inclusive (i.e., greater than or equal to 0.03 and less than or equal to 0.35).

(7) In the pet sheet according to any one of (1) to (6), a Qmax value may be 1.0 W/cm² or less.

(8) In the pet sheet according to any one of (1) to (7), the back sheet may be an air-permeable sheet.

(9) In the pet sheet according to any one of (1) to (8), the top sheet, the back sheet, and the absorbent body may be arranged so that a stiffness of a region where the absorbent body is present is 0.1 to 3.0 mN, inclusive (i.e., greater than or equal to 0.1 and less than or equal to 3.0 mN).

(10) The pet sheet according to any one of (1) to (9) may not have a fold line.

(11) In the pet sheet according to any one of (1) to (10), the adhesive surface may be arranged in a flap region where the absorbent body is not present in a plan view.

(12) The pet sheet according to any one of (1) to (10) may have no adhesive surface in a flap region where the absorbent body is not present in a plan view.

(13) The pet sheet according to any one of (1) to (11) may have a flap region where the absorbent body is not present in a plan view, and a light transmittance of the flap region may be higher than a light transmittance of a region where the absorbent body is present in the plan view.

(14) In the pet sheet according to (13), the light transmittance of the flap region may be 38.4% or more.

(15) In the pet sheet according to (13) or (14), a portion where the top sheet and the back sheet do not overlap with each other in the plan view may be present in the flap region.

(16) In the pet sheet according to any one of (1) to (15), a total length of non-adhesive surfaces on which adhesive surfaces are not arranged, in a product length direction or in a product width direction, may be longer than a total length of adhesive surfaces in a plan view.

(17) In the pet sheet according to (16), the total length of the non-adhesive surfaces on which the adhesive surfaces are not arranged, in both the product length direction and the product width direction, may be longer than the total length of the adhesive surfaces in the plan view.

(18) In the pet sheet according to any one of (1) to (17), the adhesive surface may not be present in a divided region arranged in a center of nine divided regions made by intersection of lines that divide a region where the absorbent body is present into three equal segments in a product length direction and lines that divide the region into three equal segments in a product width direction in a plan view.

(19) The pet sheet according to any one of (1) to (18) may further comprise a release paper that covers the adhesive surface, wherein the release paper has a non-joining end part that is not joined to the adhesive surface, and has a flap region where the absorbent body is not present in a plan view, and a portion where the non-joining end part and the flap region overlap with each other in the plan view may be present.

(20) In the pet sheet according to (19), a stiffness of the release paper may be greater than a stiffness of the flap region.

(21) In the pet sheet according to (20), the stiffness of the release paper may be less than a stiffness of a region where the absorbent body is present.

(22) The pet sheet according to any one of (1) to (21) may further comprise a release paper that covers the adhesive surface, wherein the release paper has a non-joining end part that is not joined to the adhesive surface, and the non-joining end part is present in both a product longitudinal direction and a product transverse direction in a plan view.

(23) In the pet sheet according to (22), the non-joining end part may have different lengths in the product longitudinal direction and in the product transverse direction.

(24) In the pet sheet according to (22) or (23), the release paper may have a mark indicating a peel-off in a product oblique direction.

(25) In the pet sheet according to any one of (22) to (24), the release paper may be composed of a single sheet.

(26) In the pet sheet according to any one of (19) to (25), a plurality of the adhesive surfaces may be present and the pet sheet may include a plurality of the release papers, each covering the plurality of the adhesive surfaces.

(27) In the pet sheet according to (26), the adhesive surfaces may be arranged at four corners of the back sheet and the pet sheet may include the plurality of the release papers, each covering the adhesive surfaces.

(28) In the pet sheet according to any one of (19) to (26), the adhesive surfaces may be present in a product central part and a product side part in the plan view, and a length of the adhesive surface present in the product central part in a product width direction may be longer than a length of the adhesive surface present in the product side part in the product width direction.

(29) In the pet sheet according to any one of (19) to (26), the adhesive surfaces may be present in a product central part and a product side part in the plan view, and a length of the adhesive surface present in the product central part in a product width direction may be shorter than a length of the adhesive surface present in the product side part in the product width direction.

(30) In the pet sheet according to any one of (19) to (26), a direction in which the adhesive surface extends and a direction in which the non-joining end part extends may be the same, and the adhesive surfaces may be intermittently arranged in a direction orthogonal to the direction in which the non-joining end part extends.

(31) In the pet sheet according to (30), a product end part that intersects a direction in which the adhesive surface extends may be joined to the adhesive surface.

(32) A kit according to one aspect of one or more embodiments comprises the pet sheet according to any one of (1) to (31), and an animal excrement disposal sheet including a liquid-permeable top sheet, a liquid-impermeable back sheet, and an absorbent body arranged between these sheets.

(33) In the kit according to (32), a color of a region where the absorbent body of the pet sheet is present and a color of a region where the absorbent body of the animal excrement disposal sheet is present may be of the same color system in a plan view.

(34) In the kit according to (32) or (33), a maximum length L2 of the pet sheet may be greater than a maximum length L1 in a longitudinal or transverse direction when 30 cc of artificial urine is dropped on the animal excrement disposal sheet.

(35) An animal excrement disposal sheet according to one aspect of one or more embodiments is an animal excrement disposal sheet used for overlaying a pet sheet at an excretion site, the animal excrement disposal sheet comprising: a liquid-permeable top sheet; a liquid-impermeable back sheet; and an absorbent body arranged between these sheets, wherein a maximum length L2 of the pet sheet is greater than a maximum length L1 in a longitudinal or transverse direction when 30 cc of artificial urine is dropped on the animal excrement disposal sheet.

(36) A use of the pet sheet according to an aspect of one or more embodiments is a use of a pet sheet, comprising: attaching a pet sheet having a light transmittance of 60% or more and having one side of a product of 13 to 17 cm, inclusive, to an animal excrement disposal sheet, in which in the animal excrement disposal sheet, a maximum length L1 in a longitudinal or transverse direction when 30 cc of artificial urine is dropped on the animal excrement disposal sheet is less than 17 cm.

(37) A use of a pet sheet according to an aspect of one or more embodiments is a use of an animal excrement disposal sheet, comprising: reusing the animal excrement disposal sheet by covering a urine trace on the animal excrement disposal sheet with a pet sheet having a light transmittance of 60% or more and having one side of a product of 13 to 17 cm, in which a maximum length L2 of the pet sheet is greater than a maximum length L1 in a longitudinal or transverse direction when 30 cc of artificial urine is dropped on the animal excrement disposal sheet.

According to one or more embodiments, a pet sheet to be overlaid in use, which makes it possible for an owner to simply prepare a clean excrement disposal sheet, and with which a pet is less likely to feel a discomfort from urine traces and the like; and a kit including the pet sheet can be provided.

### BRIEF DESCRIPTION OF THE DRAWINGS

FIG. 1 is a perspective view of a pet sheet according to one or more embodiments.

FIG. 2 is a cross-sectional view of the pet sheet according to one or more embodiments, taken along a line II-II in FIG. 1.

FIG. 3 is a plan view of the pet sheet according to one or more embodiments.

FIG. 4 is a schematic cross-sectional view of a pet sheet according to Examples.

FIG. 5 is a plan view showing an arrangement example of adhesive surfaces in the pet sheet according to one or more embodiments.

FIG. 6 is a schematic cross-sectional view showing an arrangement example of the adhesive surfaces in the pet sheet according to one or more embodiments.

FIG. 7 is a plan view showing an arrangement example of the adhesive surfaces in the pet sheet according to one or more embodiments.

FIG. 8 is a schematic cross-sectional view showing an arrangement example of the adhesive surfaces in the pet sheet according to one or more embodiments.

FIG. 9 is a plan view showing an arrangement example of adhesive surfaces in the pet sheet according to one or more embodiments.

FIG. 10 is a schematic cross-sectional view showing an arrangement example of the adhesive surfaces in the pet sheet according to one or more embodiments.

FIG. 11 is a plan view showing an arrangement example of the adhesive surfaces in the pet sheet according to one or more embodiments.

FIG. 12 is a schematic cross-sectional view showing an arrangement example of the adhesive surfaces in the pet sheet according to one or more embodiments.

FIG. 13 is a plan view showing an arrangement example of adhesive surfaces in the pet sheet according to one or more embodiments.

FIG. 14 is a plan view showing an arrangement example of adhesive surfaces in the pet sheet according to one or more embodiments.

FIG. 15 is a plan view of the pet sheet according to one or more embodiments.

FIG. 16 is a schematic cross-sectional view of the pet sheet according to Examples.

FIG. 17 is a plan view showing an arrangement example of a release paper in the pet sheet according to one or more embodiments.

FIG. 18 is a plan view showing an arrangement example of the adhesive surfaces in the pet sheet according to one or more embodiments.

FIG. 19 is a plan view showing an arrangement example of the adhesive surfaces in the pet sheet according to one or more embodiments.

FIG. 20 is a plan view showing an arrangement example of the adhesive surfaces in the pet sheet according to one or more embodiments.

### DESCRIPTION OF THE EMBODIMENTS

### <Pet Sheet>

Hereinafter, a pet sheet of one or more embodiments will be described in detail with reference to the accompanying drawings. Furthermore, in the present specification, “viewing an object (for example, an animal excrement disposal sheet, a top sheet, and an absorbent body) in the thickness direction of the object from an upper side in the vertical direction, in which the object is placed on a horizontal plane in order to make the excrement supply surface faces upwards in an unfolded state” is simply referred to as “planar viewing”, and the view in accordance with the planar viewing is referred to as a “plan view” unless otherwise specified.

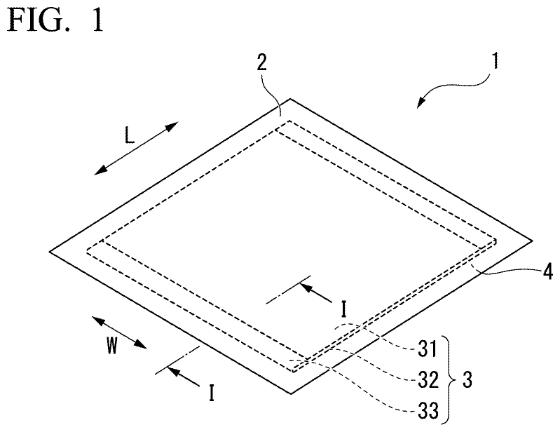

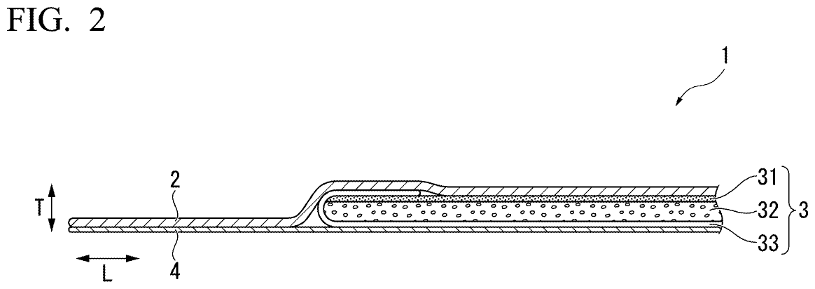

FIG. 1 is a perspective view of a pet sheet 1 according to one or more embodiments, and FIG. 2 is a cross-sectional view of the pet sheet 1 taken along a line I-I in FIG. 1.

As shown in FIG. 1, the pet sheet 1 according to one or more embodiments is a rectangular (for example square) sheet in the plan view, having a product length direction L, a product width direction W, and a thickness direction T. Furthermore, in a case where the pet sheet 1 is square in the plan view, any one side direction of the pet sheet 1 is defined as a product length direction L, and a side direction orthogonal to the product length direction L is defined as a product width W. Moreover, in one or more embodiments, the external shape of the pet sheet is not limited to such a rectangular shape, but may be any shape such as a polygon, a circle, and an ellipse may be adopted depending on various applications, design properties, and the like. In addition, the size of the pet sheet 1 can be appropriately set according to the size, type, and the like of an animal to which applied is an animal excrement disposal sheet on which the pet sheet 1 is overlaid. For example, in a case where the animal to which the animal excrement disposal sheet is applied is a dog, the length of the animal excrement disposal sheet in the product length direction may be 250 mm to 1,500 mm, 300 mm to 1,000 mm, and 400 mm to 950 mm. The length of the animal excrement disposal sheet in the product width direction may be 200 mm to 1,200 mm, 250 mm to 1,000 mm, and 300 mm to 650 mm.

The pet sheet 1 is overlaid on an animal excrement disposal sheet in use. More specifically, the pet sheet 1 is overlaid on an animal excrement disposal sheet in use to cover the excrement of the animal excrement disposal sheet which has absorbed the excrement.

The animal excrement disposal sheet typically includes a liquid-permeable top sheet, a liquid-impermeable back sheet, and an absorbent body arranged between these sheets. The animal excrement disposal sheet is placed in an unfolded state at a predetermined position in a breeding space (for example, a room) of animals such as a pet, and is used to absorb and hold excrement such as urine excreted from the animal and to maintain the breeding space in a clean state. Furthermore, the animal excrement disposal sheet may be placed directly on the floor surface or the ground surface of the breeding space, or may be placed via a predetermined holder, tray, spread material, or the like.

Here, the “animal” to which the animal excrement disposal sheet is applied is not particularly limited as long as it can be raised as a pet or the like, and mammals such as a dog, a cat, and a hamster, as well as various animals such as birds, reptiles, and amphibians can be adopted as a subject.

In addition, in one or more embodiments, the “excrement” absorbed and held by an animal excrement disposal sheet is not particularly limited as long as it can be absorbed and held in an absorbent body, and examples thereof include various body fluids such as liquid to low-viscosity feces, urine, saliva such as drool, and blood.

Pets tend to excrete on animal excrement disposal sheets while avoiding urine traces on the sheets. Therefore, in order for the pets to avoid urine traces, the pets urinate in abnormal urination postures although the bodies are on the sheets, which thus causes urination outside the animal excrement disposal sheets. In addition, depending on pets, pets may excrete outside animal excrement disposal sheets without riding over the animal excrement disposal sheets when the pets feel a discomfort from urine traces and the like on the animal excrement disposal sheets.

Owners take measures such as (a) replacing an animal excrement disposal sheet for each excrement, and (b) laying a plurality of animal excrement disposal sheets.

However, in the case of (a), it takes time and labor to replace and the amount of dust increases. In addition, in the case of (b), when a pet urinates, leakage of excrement from the border between each animal excrement disposal sheet is occurred, or the pet avoiding the center of the animal excrement disposal sheet is occurred when excreting in the second and subsequent excrements.

On the other hand, pets try to excrete on animal excrement disposal sheets as trained by owners, but there are cases where due to habits of avoiding urine traces on the sheets and trying to excrete as described above, the pets cannot correctly excrete on the animal excrement disposal sheets or the pets get their feet wet. In a case where the pets are scolded by the owners or feels an unsatisfactory attitude of the owner for the fact that the pets could not excrete correctly on the animal excrement disposal sheet, the pets feel stress.

In one or more embodiments, the pet sheet 1 is used to cover a urine trace by being overlaid on a urine trace on an animal excrement disposal sheet. Due to that, the owner can hide the urine trace on the animal excrement disposal sheet, and can easily prepare a clean excrement disposal sheet (“overlay sheet”, in which the pet sheet 1 is overlaid on the animal excrement disposal sheet after use). On the other hand, the pet is less likely to feel a discomfort such as from a urine trace and the like on the animal excrement disposal sheet. Therefore, the pet can correctly ride over the overlay sheet during excrement and is less likely to avoid a site where the urine trace is present, which makes it less likely to leak the urine outside the overlay sheet or to get the pet's feet wet. Due to that, both the owner and the pet can reduce the stress related to excretion, making it possible for the owner and the pet to recognize each other's presence more deeply and to build a loving relationship.

As shown in FIGS. 1 and 2, the pet sheet 1 according to one or more embodiments includes a liquid-permeable top sheet 2 that forms a supply surface (hereinafter sometimes referred to as a “first surface”) of excrement excreted by an animal in a thickness direction T; a liquid-impermeable back sheet 4 that forms a surface on which the pet sheet 1 is placed (that is, a surface that faces the surface of the animal excrement disposal sheet on which the pet sheet is placed), which is a surface on the opposite side to the excrement supply surface (hereinafter sometimes referred to as a “second surface”); and an absorbent body 3 having liquid-absorbing properties, arranged between these sheets. The top sheet 2 and the back sheet 4 are joined to each other at their own peripheral edge parts by any joining means such as a hot-melt adhesive.

The back sheet 4 has adhesive surfaces. Since the adhesive surfaces of the back sheet 4 abut on a urine trace on the animal excrement disposal sheet, the owner can easily hide the urine trace and can reliably hide the urine trace. In addition, the adhesive makes it possible to prevent the pet sheet from being displaced when the pet rides over the pet sheet, and thus, the animal is less likely to feel a discomfort.

Examples of the adhesive that constitutes the adhesive surface include synthetic rubber (SIS, SBS, and the like).

In addition, in one or more embodiments, the back sheet 4 may have an uneven structure as an adhesive region.

Furthermore, the arrangement configuration of the adhesive surface of the back sheet 4 will be described later.

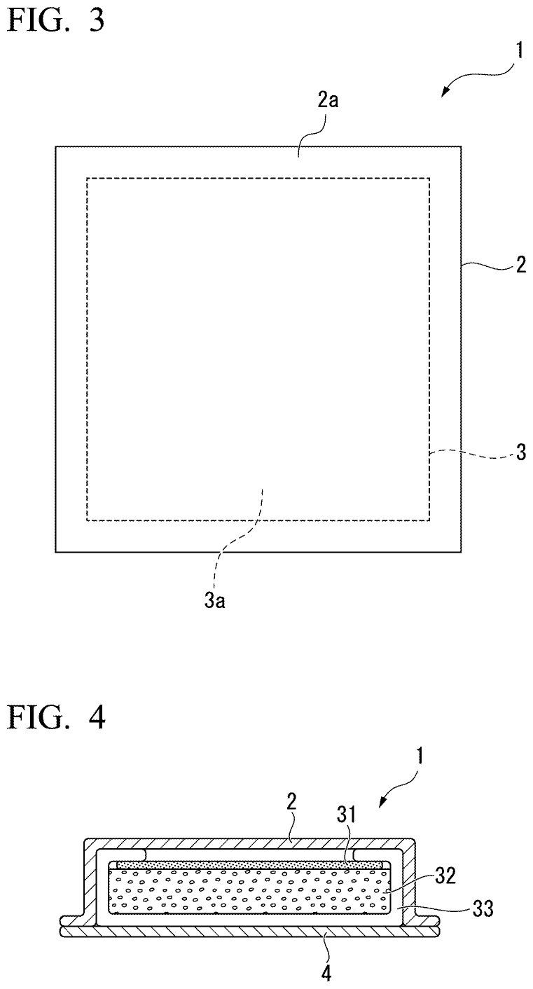

FIG. 3 is a plan view of the pet sheet according to one or more embodiments. In the pet sheet 1, the top sheet 2, the back sheet 4, and the absorbent body 3 are arranged so that the light transmittance may be 60% or less, 40% or less, and 30% or less. Typically, in the plan view of the pet sheet 1, the light transmittance in a region 3a where the top sheet 2, the back sheet 4, and the absorbent body 3 are present is 60% or less.

In one or more embodiments, the light transmittance is measured in accordance with JIS K7361-1:1997. Specifically, standard calibration is performed in accordance with the provisions of a haze meter such as HAZE Meter NDH 7000SP II (NIPPON DENSHOKU INDUSTRIES Co., Ltd.), and a sample obtained by cutting out the central portion of the pet sheet 1, where the absorbent body 3 is present, at 30 mm×30 mm is set and measured. Furthermore, the size of the sample can be appropriately modified according to a measuring instrument and a sample.

A light transmittance of the pet sheet 1 according to one or more embodiments set to 60% or less makes it less likely for the pet to visually recognize a urine trace when viewing the overlay sheet. Therefore, the pet can correctly ride over the overlay sheet during excrement and is less likely to avoid a site where the urine trace is present, which makes it less likely to leak the urine outside the overlay sheet or to get the pet's feet wet. Particularly, an owner who keeps a pet in a room is less likely to visually recognize a urine trace, and accordingly, the sheet maintains a clean state, which makes it possible for him/her to feel a comfortable living environment.

The pet sheet 1 according to one or more embodiments may have a product thickness of greater than 0.2 mm and 10 mm or less, 1.0 mm or more and 7.0 mm or less, or 1.5 mm or more and 5.0 mm or less.

In a case where the product thickness of the pet sheet 1 is equal to or greater than the lower limit value of the range, it is less likely to feel a urine trace simply by allowing the owner to overlay the pet sheet on the animal excrement disposal sheet. In addition, in a case where the product thickness is equal to or greater than the lower limit value of the range, the pet is less likely to visually recognize a urine trace when viewing the overlay sheet, making it likely for the pet to recognize the overlay sheet as a new animal excrement disposal sheet and making it less likely to avoid the urine trace.

On the other hand, in a case where the product thickness is equal to or less than the upper limit value of the range, when the pet sheet is overlaid on the animal excrement disposal sheet, the owner is less likely to feel a discomfort that something is overlaid on the animal excrement disposal sheet to hide the urine trace. In addition, in a case where the product thickness is equal to or less than the upper limit value of the range, the pet is less likely to feel a discomfort that a foreign matter is present on the overlay sheet before riding over the overlay sheet, making it less likely to avoid the overlay sheet. Accordingly, the pet no longer urinates in a position unrelated to the sheet.

In one or more embodiments, the product thickness of the pet sheet 1 can be measured using a commercially available thickness measuring device such as a PEACOCK Thickness Gauge J-B 0.05 mm (manufactured by OZAKI MFG. CO., LTD.). Specifically, in the plan view of the pet sheet 1, the thickness is measured using a thickness measuring device in each of the central parts of nine divided regions made by intersection of lines that divide the region 3a into three equal segments in the product length direction L and lines that divide the region 3a into three equal segments in the product width direction W, and an average value of the thicknesses of the nine points can be used as the product thickness.

In the pet sheet 1 according to one or more embodiments, the top sheet 2, the back sheet 4, and the absorbent body 3 may be arranged so that an area of the region where the absorbent body 3 is present may be 80% or less, 75% or less, and 65% or less of the entire surface of the pet sheet 1 in the plan view. Typically, in the plan view of the pet sheet 1, the area of the region 3a where the top sheet 2, the back sheet 4, and the absorbent body 3 are present can be configured to be 80% or less, 75% or less, or 65% or less of the entire surface of the pet sheet 1.

In a case where the area of the region where the absorbent body 3 is present is within the range, a flap region 2a (flap part 2a which will be described later) where there is no absorbent body is a region where excrement is not held, which makes it easy for the owner to grasp this region (removal position) and thus to remove the pet sheet.

In the pet sheet 1 according to one or more embodiments, the back sheet 4 and the absorbent body 3 may be arranged so that a difference between a thickness of a region where the absorbent body 3 is present and a thickness of a flap region where the absorbent body 3 is not present may be 0.3 mm or more and 5 mm or less, 1.0 mm or more and 3 mm or less, and 1.0 mm or more and 2 mm or less. Typically, in the plan view of the pet sheet 1, a difference between the thickness of the region 3a in which the top sheet 2, the back sheet 4, and the absorbent body 3 are present and the thickness of the flap region 2a where the absorbent body 3 is not present can be configured to be 1.0 mm or more and 5 mm or less, 1.0 mm or more and 3 mm or less, or 1.0 mm or more and 2 mm or less.

In a case where the difference between the thickness of the region where the absorbent body 3 is present and the thickness of the flap region where the absorbent body 3 is not present is equal to or greater than the lower limit value of the range, it is easier for the owner to visually recognize the removal position of the pet sheet.

On the other hand, in a case where the difference between the thickness of the region where the absorbent body 3 is present and the thickness of the flap region where the absorbent body 3 is not present is equal to or less than the upper limit value of the range, when the pet sheet is overlaid on the animal excrement disposal sheet, the owner is less likely to feel a discomfort that something is overlaid on the animal excrement disposal sheet to hide the urine trace. In addition, the pet does not feel a discomfort that a foreign matter is present on the overlay sheet before riding over the overlay sheet, making it less likely to avoid the overlay sheet.

The pet sheet 1 according to one or more embodiments may have a size of a product of 1,500 cm² or less, 900 cm² or less, or 300 cm² or less.

In a case where the size of a product is within the range, it is easier for the owner to attach and detach the sheet to and from the animal excrement disposal sheet with one hand. In addition, the pet does not feel a discomfort that a foreign matter is present on the overlay sheet before riding over the overlay sheet, making it less likely to avoid the overlay sheet.

In the pet sheet 1 according to one or more embodiments, the dimensions of the product length and the product width (product length×product width) may be 38 cm or less×38 cm or less, and may be 30 cm or less×30 cm or less, 20 cm or less×20 cm or less, and 17 cm or less×17 cm or less. In a case where the dimensions of the product length and the product width are equal to or less than the upper limit value of the range, it is easier for the owner to attach and detach the sheet to and from the animal excrement disposal sheet with one hand. In addition, the pet does not feel a discomfort that a foreign matter is present on the overlay sheet before riding over the overlay sheet, making it less likely to avoid the overlay sheet.

On the other hand, in the pet sheet 1 according to one or more embodiments, the dimension of the product length and the product width (product length× product width) may be 7 cm or more×7 cm or more, 10 cm or more×10 cm or more, and 13 cm or more×13 cm or more. In a case where the dimensions of the product length and the product width are equal to or greater than the lower limit value of the range, it is easy to hide urine traces with the pet sheet 1.

In the pet sheet 1 according to one or more embodiments, a WC value obtained by a KES compression characteristic tester may be 0.03 to 0.35, 0.05 to 0.30, and 0.10 to 0.25.

In general, the animal excrement disposal sheet often includes a super-absorbent polymer (SAP) in a lower layer sheet. Since the SAP that has absorbed excrement partially swells, a pet feels a tactile feeling similar to a gel, and thus, may feel discomfort when it steps on a bulging portion. In a case where the WC value of the pet sheet 1, obtained by the KES compression characteristic tester, is equal to or greater than the lower limit value of the range, it is less likely for the pet to feel a discomfort due to a tactile feeling of a urine trace in the lower layer sheet when the pet steps on the overlay sheet. Therefore, when the pet rides over the sheet, the pet can urinate at a correct position while not avoiding such a position. Due to that, a possibility that the pet urinates out of the sheet can be reduced. On the other hand, in a case where the WC value is equal to or less than the upper limit value of the range, the pet is less likely to feel a discomfort to a pad when riding over the pet sheet, making it less likely to avoid the pet sheet.

In one or more embodiments, the WC values obtained by the KES compression characteristic tester are measured using a commercially available compression tester such as a KES-FB3-AUTO-A compression tester (KATO TECH CO., LTD.). Specifically, in the plan view of the pet sheet 1, a region (region 3a) where the absorbent body 3 is present is cut out into samples having a size of 30 mm×30 mm, the samples are gently pinched at a center of the sample between disks positioned above and below the sample, and a thickness dimension TO of each sample is measured with a compression area (area of the disk) of 2.0 cm² under a load of 0.49 hPa. Next, the measurement sample is compressed to reach a load of 49.03 hPa at a pressurization rate of 0.02 mm/sec, and a thickness dimension Tm under the load of 49.03 hPa is measured. In addition, a workload (N·m/m²) WC required during compression is determined from the thickness dimension T0 to the thickness dimension Tm.

In the pet sheet 1 according to one or more embodiments, the Qmax value may be 1.0 W/cm² or less, and 0.5 W/cm² or less, and 0.1 W/cm² or less.

In a case where the Qmax value is within the range, the pet is less likely to feel a cool tactile feeling from an excrement trace in the lower layer sheet of the animal excrement disposal sheet when stepping on the overlay sheet, making it less likely for the pet to avoid the overlay sheet without feeling a discomfort.

In one or more embodiments, the Qmax value of the pet sheet 1 can be measured using a commercially available heat flow rate measuring device such as Thermo Labo KES-F7 (manufactured by KATO TECH CO., LTD.). Specifically, the absorbent core or non-absorbent core region is placed on a Thermocool (constant-temperature stand) set at 20° C. and left for a while, a sensor part of T-Box which has been heated to 30° C. is then placed so that the sample and the sensor part face each other to be in contact, and the Qmax value is measured.

In one or more embodiments, the top sheet, the back sheet, and the absorbent body may be arranged in the pet sheet 1 so that a stiffness in the region where the absorbent body 3 is present may be 0.1 to 3.0 mN, 0.5 to 2.0 mN, and 0.7 to 1.5 mN. Typically, in the plan view of the pet sheet 1, a stiffness of the regions 3a where the top sheet 2, the back sheet 4, and the absorbent body 3 are present may be 0.1 to 3.0 mN, 0.5 to 2.0 mN, and 0.7 to 1.5 mN.

In a case where the stiffness of the region where the absorbent body 3 is present is within the range, the pet sheet itself is less likely to be folded when the owner lifts the pet sheet, which makes it easy to neatly install the pet sheet on the animal excrement disposal sheet while maintaining the shape of the pet sheet with one hand. In addition, when the stiffness of the region where the absorbent body 3 is present is within the range, an appropriate stiffness is obtained, which makes it less likely for the pet to feel a discomfort when riding over the pet sheet, and makes it less likely for the pet to avoid the pet sheet.

In addition, in a case where the top sheet 2, the back sheet 4, and the absorbent body 3 are arranged so that the area of the region where the absorbent body 3 is present is 90% or less of the entire surface of the pet sheet 1 and the stiffness of the region where the absorbent body 3 is present is within the range in the plan view, the pet sheet 1 itself is not easily folded when the owner lifts the pet sheet 1, making it possible for the owner to neatly install the pet sheet 1 with one hand while maintaining the shape of the pet sheet 1.

In one or more embodiments, the stiffness of the region where the absorbent body 3 is present can be measured by the following procedure. Furthermore, matters not described herein are according to the “6.7.4 Gurley Method” of JIS L 1913:2010 “General Non-Woven Fabric Testing Method”.

(1) In a constant-temperature and constant-humidity chamber (temperature: 25±5° C., relative humidity: 65±5%), a No. 311 Gurley-type flexibility tester manufactured by YASUDA SEISAKUSHO, LTD. is prepared.

(2) In the constant-temperature and constant-humidity chamber, a sample to be measured is allowed to stand in an unfolded state for 24 hours.

(3) A sample having a length L of 38 mm and a width d of 25 mm is cut out from the sample so that the length L extends in a predetermined direction (for example, a product length direction or a product width direction of an absorbent article). Furthermore, in a case where the absorbent article is individually packaged, a packaging sheet is removed before measurement.

(4) The sample is set such that 6.3 mm of one end part of the sample in the product length direction is held in a chuck part and 6.3 mm of the other end part of the sample in the product length direction is in contact with a pendulum B.

(5) A movable arm is rotated at a constant speed and a scale (RG1) when the sample moves away from pendulum B is read (first time). The sample is then set on a Gurley-type flexibility tester, with the front and back of the sample reversed, and a scale (RG2) when the sample moves away from pendulum B is read (second time).

(6) A stiffness (mN) is calculated from the following expression.

### Stiffness (mN)

$$= [ \frac{{RG}_{1} + {RG}_{2}}{2} ] \times ( {aW}_{a} + {bW}_{b} + {cW}_{c} ) \times \frac{{( L - 12.7 )}^{2}}{d} \times 3.375 \times {10}^{- 5} \qquad [ Expression 1 ]$$

The pet sheet 1 according to one or more embodiments may not have a fold line.

In a case where the pet sheet 1 has no fold line, a step of opening the pet sheet 1 when the pet sheet 1 is arranged on the animal excrement disposal sheet can be omitted, and the pet sheet 1 is easily attached to a urine trace on the animal excrement disposal sheet without producing wrinkles in one step.

Hereinafter, various members that constitute the pet sheet 1 according to one or more embodiments will be described in more detail.

### (Top Sheet)

As shown in FIGS. 1 and 2, the top sheet 2 is arranged on the side where excrement of an animal is supplied in the thickness direction T of the pet sheet 1, and includes a liquid-permeable sheet-like member capable of transferring excrement excreted from the animal from the excrement supply surface to a surface on the opposite side. The liquid-permeable sheet-like member that constitutes such a top sheet 2 is not particularly limited as long as the sheet-like member includes white fibers and satisfies the above-described specific requirements, and for example, any non-woven fabrics such as an air-through non-woven fabric, a spunbond non-woven fabric, and a pointbond non-woven fabric are suitably used. Furthermore, the non-woven fabric may be subjected to a hydrophilization treatment with a surfactant.

The white fibers that constitute the top sheet 2 is not particularly limited as long as the fibers have a white color, and for example, thermoplastic resin fibers to which a white pigment or a white dye is added, and a thermoplastic resin fibers having a surface structure or crystal structure capable of diffusely reflecting light is suitably used.

Among such white fibers, the white fibers constituting the top sheet may be thermoplastic resin fibers to which a white pigment is added, from the viewpoint that a top sheet that satisfies the above-described requirements is easily formed.

Here, the white pigment to be added to the thermoplastic resin fibers are not particularly limited, and examples thereof include titanium oxide (titanium white), zinc oxide (zinc white), a mixture of barium sulfate and zinc sulfide, and basic lead carbonate (lead white), but titanium oxide may be used as the white pigment from the viewpoint of a high refractive index, a low toxicity to living organisms, and the like.

Moreover, the type of the thermoplastic resin fibers are not particularly limited as long as they are fibers formed of a thermoplastic resin, and examples of the thermoplastic resin include well-known resins, such as olefin resins such as polyethylene (PE), polypropylene (PP), and an ethylene-vinyl acetate copolymer (EVA), polyester resins such as polyethylene terephthalate (PET) and polylactic acid (PLA), and polyamide resins such as 6-nylon. These resins may be used alone or in combination of two or more kinds of the resins.

The structure of the fibers formed of such a thermoplastic resin is not particularly limited, and examples of the fibers include composite fibers such as a core-sheath type fiber, a side-by-side type fiber, and an island-sea type fiber; hollow type fibers; irregular cross-section fibers such as fibers having a flat shape, a Y shape, a C shape, and the like; three-dimensional crimped fibers with a latent or overt crimp; and split fibers that are split by a physical load such as a water jet, heat, and embossing. The fibers having these structures may be used alone or in combination of two or more kinds thereof.

Among such thermoplastic resin fibers, core-sheath type thermoplastic resin fibers such as polyester (core part)/polyethylene (sheath part) may be used, and core-sheath type thermoplastic resin fibers in which the above-described titanium oxide is contained only in the core part may be used.

In a case where the above-described titanium oxide is contained in only the core part of the core-sheath type thermoplastic resin fiber, when a light incident on the fibers is reflected by the titanium oxide included in the core part, the reflected light is refracted in the sheath part that covers the outer surface of the core part and exits the fiber, making it possible to diffusely reflect the light more widely as a result. Therefore, fibers having a strong whiteness can be obtained even when the content of titanium oxide is small.

Further, in a case where the top sheet includes such specific core-sheath type thermoplastic resin fibers (that is, core-sheath type thermoplastic resin fibers that contain titanium oxide in only the core part), the joining of fibers with each other in the sheath parts by heat fusion or the like is less likely to be inhibited by titanium oxide when the top sheet is produced. Therefore, the fibers can be more reliably joined to each other and the top sheet can be more excellent in a strength. Due to that, the core part of the core-sheath type thermoplastic resin fibers that constitute the top sheet are less likely to be affected by a scratching motion and the like of animals. Therefore, the above-described action effect exerted by titanium oxide can be further continuously exhibited over a long period of time.

Furthermore, the fineness of the thermoplastic resin fibers are not particularly limited, and examples thereof include a fineness within a range of 1.1 to 8.8 dtex, but from the viewpoint of the strength or flexibility, and the liquid permeability of the non-woven fabric, the fineness of the thermoplastic resin fibers may be within a range of 1.5 to 4.6 dtex.

Further, the above-described thermoplastic resin fibers may be subjected to a hydrophilization treatment such as treatment using a surfactant, a hydrophilic agent, or the like (for example, kneading of a surfactant into the inside of the fibers and application of a surfactant to the surface of the fiber).

Moreover, in the pet sheet 1 according to one or more embodiments, the top sheet 2 may be composed of only white fibers, and may also include other fibers that are not white, or any additive. Examples of such other fibers include fibers formed of a thermoplastic resin similar to the above-described thermoplastic resin, and a content of the fibers may be 75 mass % or less of the total fibers constituting the top sheet.

In addition, examples of such any additive include perfumes, deodorants, antibacterial agents, and disinfectants. Incidentally, these additives may be used in combination of two or more kinds thereof.

In one or more embodiments, the thickness of the top sheet 2 is not particularly limited as long as it satisfies the above-described specific requirements, but may be 0.05 mm or more.

Furthermore, the thickness of the top sheet can be measured as follows using, for example, a compression tester (Model: KES-FB3 AUTO-A, manufactured by KATO TECH CO., LTD.) as a measuring device. In the measurement of the thickness of the top sheet, a measurement sample which has been sampled from the top sheet is placed in the above-described measuring device, and the thickness of the sample at a pressure applied to the measurement sample through a measurement terminal of 0.5 g/cm² is measured. As for the thickness of the top sheet, the average value of the measured values at N=10 is adopted.

In one or more embodiments, a basis weight of the top sheet 2 is not particularly limited, but may be 8 g/m² to 30 g/m², and 10 g/m² to 25 g/m².

### (Absorbent Body)

As shown in FIG. 2, the absorbent body 3 is an absorbent member which is arranged on the side of the top sheet 2 opposite to the excrement supply surface, and which absorbs and holds the excrement that has permeated the top sheet 2. The top sheet 2 and the absorbent body 3 are joined to each other with any adhesive such as a hot-melt adhesive, and the adhesive is arranged between the top sheet 2 and the absorbent body 3 in a basis weight (for example, 0.05 g/m² to 130 g/m²) and a coated form (for example, a spiral-like, dotted, or striped form) that does not hinder the permeation of the excrement.

Furthermore, in one or more embodiments, the absorbent body 3 has a substantially rectangular (for example square) external shape in the plan view as shown in FIGS. 1 and 3, and is arranged in the central region of the pet sheet 1. However, one or more embodiments are not limited to such an aspect, and the absorbent body 3 may have any shape in the plan view other than a rectangular shape, or may be arranged deviated in any direction from the center of the pet sheet 1.

In one or more embodiments, as shown in FIG. 2, the absorbent body 3 includes a hydrophilic upper sheet 31 located on the top sheet side, an absorbent core 32 located on the back sheet side and formed of an absorbent material for absorbing and holding excrement, and a core-wrapping sheet 33 formed of at least one liquid-permeable sheet that covers these upper sheets 31 and the absorbent core 32 from the back sheet side.

The upper sheet 31 includes a white tissue paper (for example, a tissue paper having a basis weight of 8 g/m² to 30 g/m², formed mainly of softwood-bleached kraft pulp), and is arranged in the absorbent body 3 to cover a surface of the absorbent core 32 on the top sheet side, thereby preventing the deformation of the absorbent core 32.

In one or more embodiments, the upper sheet 31 forms an intermediate layer having a higher density than that of the absorbent core 32. Due to that, the absorbent body 3 is more conspicuous, making it easy for the pet to recognize the absorbent body 3 as a target for excretion, and the pet can excrete at a correct position with a higher accuracy. In addition, it easier for the owner to grasp the amount of urine, the color of urine, the site for use, and the like of the pet.

Furthermore, in one or more embodiments, the upper sheet 31 and the absorbent core 32 are adhered to each other by a water spray. This water spray is an adhesive means that sprays water onto the upper surface (that is, the surface of the pet sheet 1 on the top sheet 2 side) of the absorbent core 32 (specifically, a first absorbent core 321 formed of an absorbent polymer 321a) and attaches the upper sheet 31 thereonto when the absorbent body 3 is produced. Furthermore, since the sprayed water evaporates thereafter and the sprayed portions of the water is in a dry state, the above-described upper sheet 31 and the absorbent core 32 are in a state of being directly joined. In a case where the upper sheet 31 and the absorbent core 32 are adhered to each other by such a water spray, no adhesive is interposed between the upper sheet 31 and the absorbent core 32, and excrement such as urine which has transferred from the top sheet side can be rapidly absorbed into the absorbent core 32, which makes it possible to exert a deodorizing effect immediately after excrement of an animal, and thus makes it possible to provide an animal owner and the like with a comfortable breeding environment.

The sheet member that constitutes the upper sheet 31 is not particularly limited, and any non-woven fabric such as an air-through non-woven fabric and a spunbond non-woven fabric can be used in addition to the above-described tissue paper.

### (Absorbent Core)

In one or more embodiments, the absorbent core 32 includes a granular absorbent polymer. The absorbent polymer used in one or more embodiments is not particularly limited as long as it is capable of absorbing and holding a liquid, and any super-absorbent polymer such as a polyacrylic acid-based polymer, a starch-based polymer, or a cellulose-based polymer can be employed.

The basis weight of the absorbent core 32 may be 15 g/m² to 480 g/m², 55 g/m² to 385 g/m², and 80 g/m² to 290 g/m².

In addition, in one or more embodiments, the core-wrapping sheet 33 includes a tissue paper similar to the above-described upper sheet 31 (for example, a tissue paper formed mainly of softwood-bleached kraft pulp), and is arranged in the absorbent body 3 to cover the upper sheet 31 and the absorbent core 32 from the back sheet side, thereby preventing the deformation of the absorbent core 32, the positional deviation of the upper sheet 31, and the like.

In one or more embodiments, the core-wrapping sheet is not particularly limited as long as it has liquid permeability and can prevent the deformation of the absorbent core, and the like, and any non-woven fabric such as an air-through non-woven fabric and a spunbond non-woven fabric can be used in addition to the above-described tissue paper.

### (Back Sheet)

In one or more embodiments, as shown in FIG. 2, the back sheet 4 is arranged to face the floor surface or the ground surface on which the pet sheet 1 is placed in the thickness direction T of the pet sheet 1, and includes a liquid-impermeable sheet member that prevents the leakage of excrement excreted from an animal.

The liquid-impermeable sheet member that constitutes such a back sheet 4 is not particularly limited, and for example, an air-impermeable resin film such as polyethylene and polypropylene, a laminate obtained by attaching a non-woven fabric to the resin film, a water-repellent or hydrophobic non-woven fabric, or the like is suitably used.

The back sheet 4 has adhesive surfaces 4a. The arrangement configuration of the adhesive surfaces 4a in the back sheet 4 is not particularly limited. For example, the adhesive surfaces 4a may be arranged in a flap region (flap part 2a) where the absorbent body 3 is not present in the plan view. In a case where the adhesive surfaces 4a are present in the flap part 2a, when the owner attaches the pet sheet 1 to the animal excrement disposal sheet, there is no gap between the flap part 2a and the lower layer sheet of the animal excrement disposal sheet, making it easy to attach the pet sheet simple and clean so that excrement traces do not come out after the attachment. In addition, a risk can be reduced that the pet notices the presence of the pet sheet 1 because of the release of the flap part 2a and does not ride over the overlay sheet. Furthermore, there is also a reduced concern that the pet sheet may turn up by the foot being caught by the flap part.

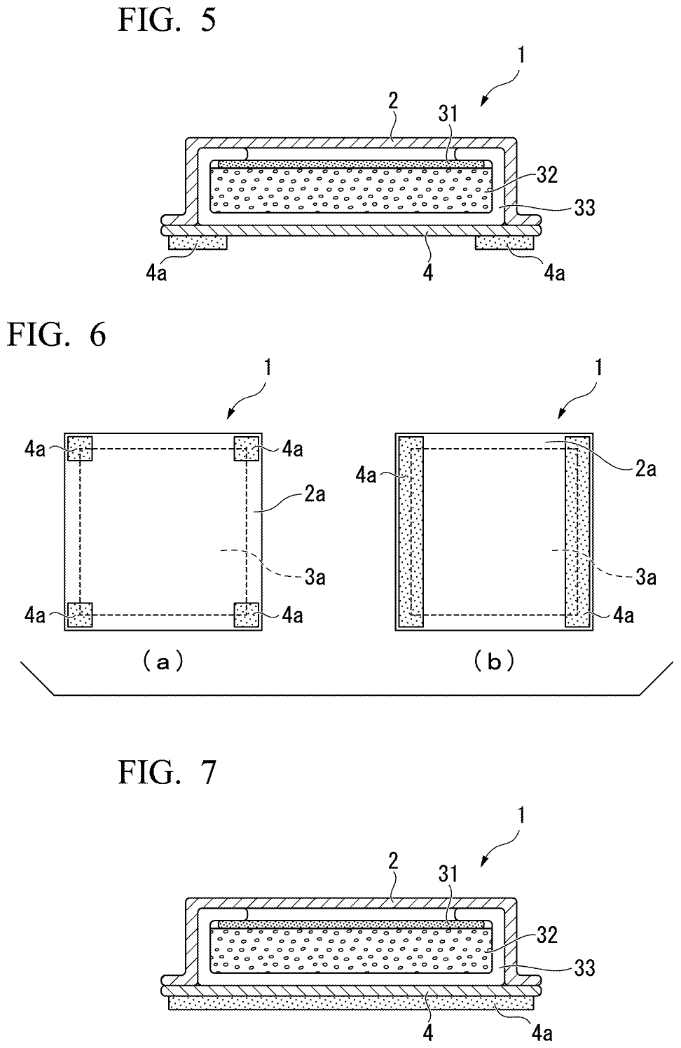

FIGS. 5, 7, and 9 are plan views each showing an arrangement example of the adhesive surfaces in the pet sheet according to one or more embodiments. FIGS. 6, 8, and 10 are schematic cross-sectional views each showing an arrangement example of the adhesive surfaces in the pet sheet according to one or more embodiments.

In the examples shown in FIGS. 5 and 6, the adhesive surfaces 4a are present in a part of the flap part 2a in the plan view and arranged only in a predetermined portion of the back sheet 4. In addition, as shown in FIG. 6(a), the adhesive surfaces 4a may be arranged only at the corner parts of the back sheet 4, and as shown in FIG. 6(b), the adhesive surfaces 4a may be arranged in a rectangular shape along the end parts of the back sheet 4.

According to the aspects of FIGS. 5 and 6, since the adhesive surface is not present in at least a part of the flap part, it is easy to adopt a configuration in which an end part of the flap part is slightly floated from the lower layer sheet of the animal excrement disposal sheet. Therefore, in a case where the owner attaches the pet sheet onto a wrong position, the pet sheet is easily peeled off from the animal excrement disposal sheet during reattachment of the pet sheet, making it easy to reattach. In addition, the absence of the adhesive member at the center of the absorbent core makes it easy to feel the odor of excrement emitted from the lower layer sheet.

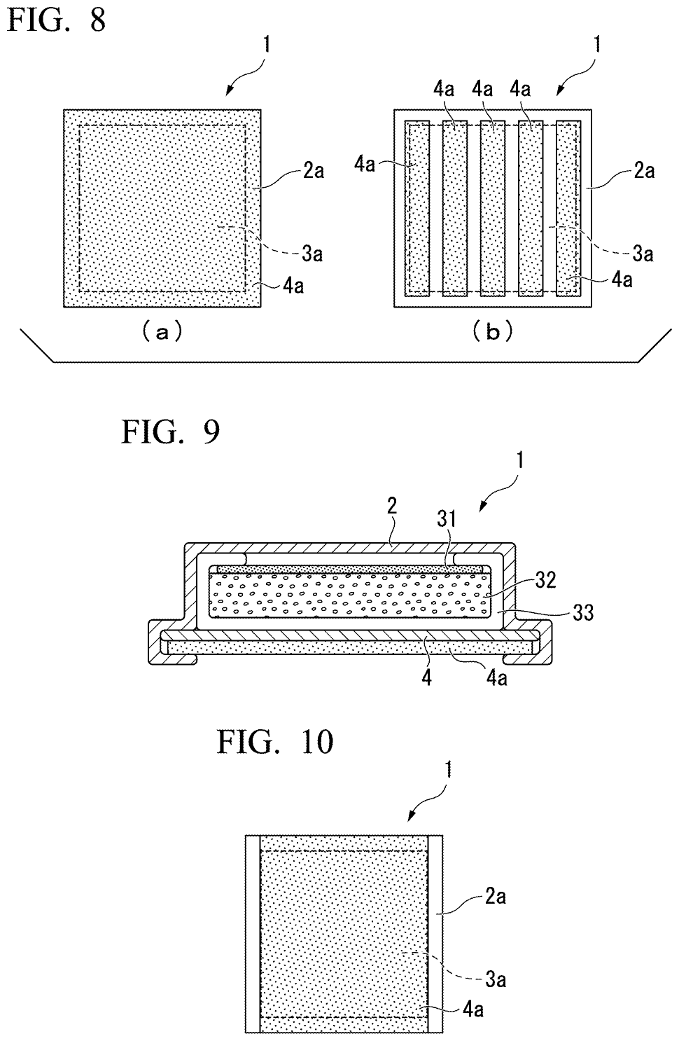

In the examples shown in FIGS. 7 and 8, the adhesive surfaces 4a are present on a part or the entire flap part 2a in the plan view and arranged across the entire surface of the back sheet 4. In addition, as shown in FIG. 8(a), the adhesive surfaces 4a may be arranged to cover substantially the entire surface of the back sheet 4, or as shown in FIG. 8(b), the adhesive surfaces 4a may be arranged in a rectangular shape to cover the entire surface of the back sheet 4.

According to the aspects of FIGS. 7 and 8, the presence of an adhesive in the region that overlaps with the absorbent core makes it less likely to be displaced during the attachment. In addition, when the pet touches the sheet, the sheet is less likely to be displaced and the pet is less likely to feel a discomfort of the sheet.

In the examples shown in FIGS. 9 and 10, the adhesive surfaces 4a are present on the entire flap part 2a in the plan view and arranged across the entire surface of the back sheet 4. In addition, the top sheet 2 is folded to cover the end parts of the back sheet 4.

According to the aspects of FIGS. 9 and 10, there is an adhesive on the entire surface of the region where the absorbent core is present, which makes it less likely for the sheet to be displaced when the pet rides over the sheet, and makes it easy for the owner to peel off the sheet due to the presence of the non-adhesive part on the side parts. Furthermore, since the non-adhesive portion includes the top sheet 2 (non-woven fabric) on the front surface and the back surface, a soft texture can be achieve (as compared with a film) when the owner peels off.

In addition, in one or more embodiments, the pet sheet 1 may not have the adhesive surfaces 4a in the flap region (flap part 2a) where the absorbent body 3 is not present in a plan view.

Since the adhesive surface is not present in the flap part, it is easy to adopt a configuration in which the end part of the flap part is slightly floated from the lower layer sheet of the animal excrement disposal sheet. Therefore, in a case where the owner attaches the pet sheet onto a wrong position, the pet sheet is easily peeled off from the animal excrement disposal sheet during reattachment of the pet sheet, making it easy to reattach.

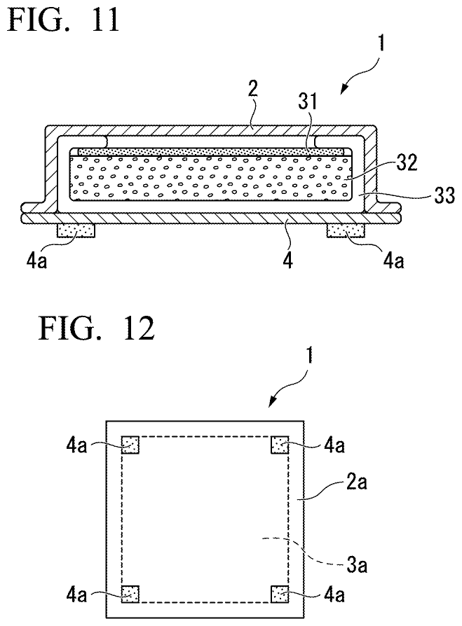

FIG. 11 is a plan view showing an arrangement example of the adhesive surfaces in the pet sheet according to one or more embodiments. FIG. 12 is a schematic cross-sectional view showing an arrangement example of the adhesive surfaces in the pet sheet according to one or more embodiments.

In the examples shown in FIGS. 11 and 12, the adhesive surfaces 4a are not present in the flap part 2a in the plan view, and are present only in the region 3a and arranged only in a predetermined portion of the back sheet 4. As shown in FIG. 12, the adhesive surfaces 4a may be arranged only at the corner parts of the region 3a, or may be arranged at another portion of the region 3a.

In one or more embodiments, the back sheet 4 may be an air-permeable sheet.

In a case where the back sheet 4 is the air-permeable sheet and the pet comes close to the overlay sheet in order to urinate, the odor of excrement emitted from the lower layer sheet of the animal excrement disposal sheet can be felt, making it possible to accurately grasp an appropriate excrement position.

In one or more embodiments, the pet sheet 1 may have a flap region (flap part 2a) where the absorbent body 3 is not present in the plan view, and a light transmittance of the flap region may be higher than a light transmittance of the region (region 3a) where the absorbent body is present in the plan view. Specifically, the light transmittance of the flap part is higher than the light transmittance of the region where the absorbent body is present in the plan view, and may be 38.4% or more, and 63.9% or more.

In a case where the light transmittance of the flap part 2a is higher than the light transmittance of the region 3a, while the light transmittance of the region 3a is lowered to make it easy to hide urine traces, it is easier to visually recognize the urine that seems to protrude from the region 3a, making it easy to understand when it is time to replace the pet sheet.

A portion where the top sheet and the back sheet do not overlap with each other in the plan view may be present in the flap region 2a.

In a case where a portion where the top sheet and the back sheet do not overlap with each other in the plan view is present in the flap region 2a, the light transmittance of the portion is further lowered, and thus, it is easier to visually recognize urine that seems to protrude from the product end part, making it easy to understand when it is time to replace the pet sheet.

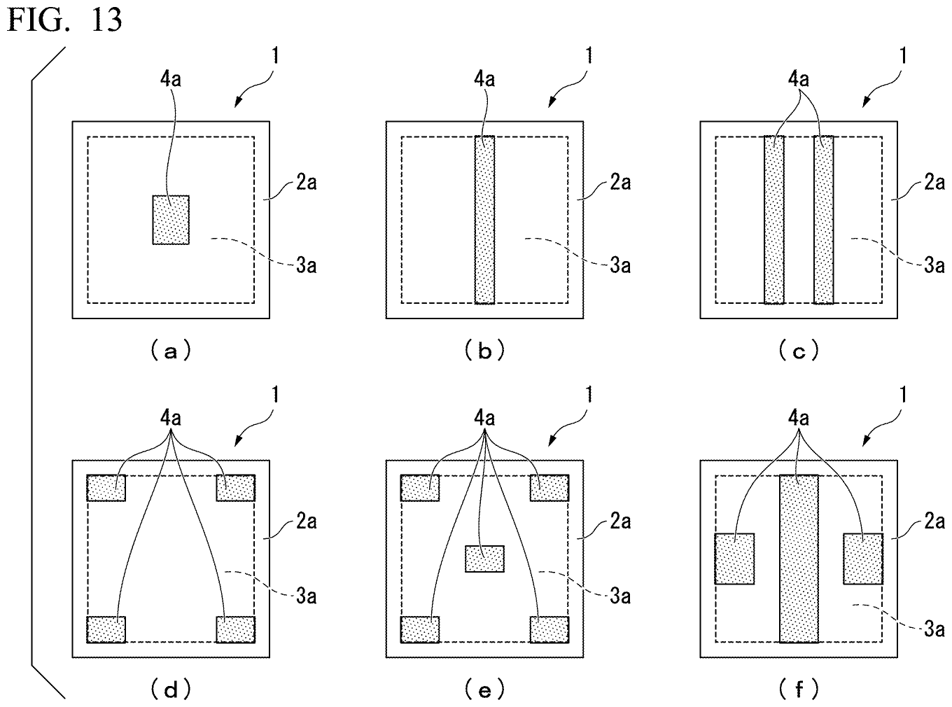

In one or more embodiments, for example, as shown in FIG. 13, the pet sheet 1 may have a total length of the non-adhesive surfaces on which the adhesive surfaces are not arranged, which is longer than a total length of the adhesive surfaces in a product length direction or in a product width direction, or in both the product length direction and the product width direction in the plan view.

In a case where the total length of the non-adhesive surfaces on which the adhesive surfaces are not arranged is longer than the total length of the adhesive surfaces in the product length direction and/or in the product width direction in the plan view, when it is necessary to correct the position where the pet sheet is attached, a hand is easily inserted, and since the force of engagement is weak, the pet sheet is easily peeled off by flipping.

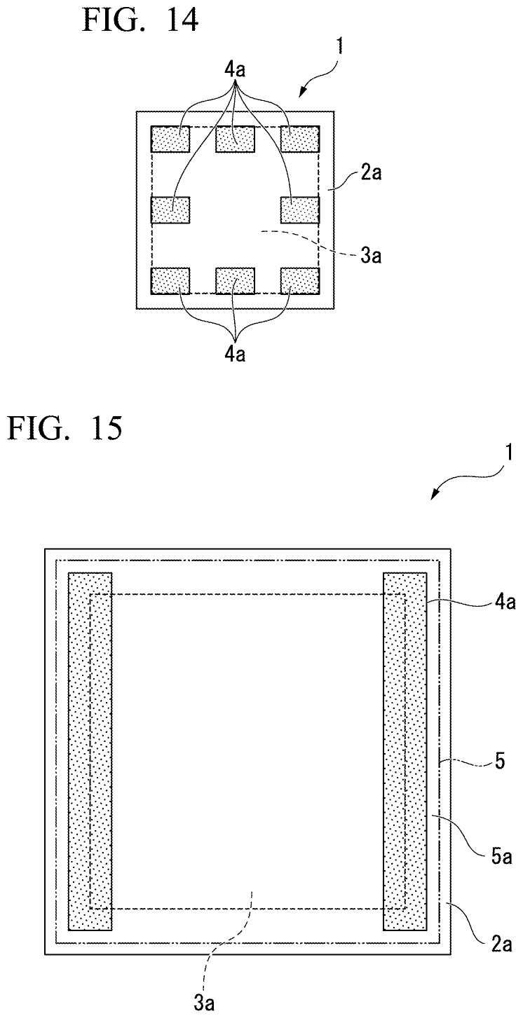

In one or more embodiments, for example, as shown in FIG. 13(d) or FIG. 14, the pet sheet 1 may have a configuration in which the adhesive surface is not present in a divided region arranged in the center of nine divided regions made by intersection of lines that divide a region where the absorbent body is present into three equal segments in the product length direction and lines that divide the region into three equal segments in the product width direction in the plan view.

In a case where the adhesive surface is not present in the divided region arranged in the center, even when the pet sheet is attached so that the central portion of the pet sheet covers the urine trace, the divided region is less likely to be adhered to the animal excrement disposal sheet by urine, making it easy to peel off the pet sheet. In addition, in a case where the adhesive surface is not present in the divided region, a total area of the adhesive surfaces can be reduced, making it easy to prevent self-adhesion in which the adhesive surfaces are joined to each other in a state where the adhesive surfaces are exposed. Particularly, the present effect appears remarkably when the release paper is peeled off.

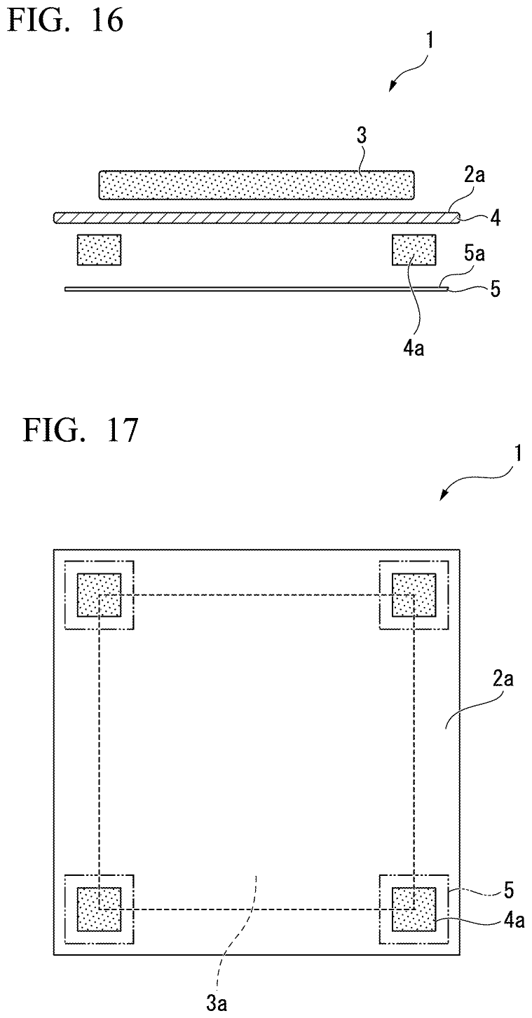

FIG. 15 is a plan view of the pet sheet according to one or more embodiments. FIG. 16 is a schematic cross-sectional view of the pet sheet according to one or more embodiments.

In the examples shown in FIGS. 15 and 16, a release paper 5 that covers the adhesive surfaces 4a of the back sheet 4 is provided. The release paper 5 is not particularly limited as long as it is capable of being peeled off from the back sheet 4 and exposing the adhesive surfaces 4a when the pet sheet is attached.

In the example shown in FIGS. 15 and 16, the release paper 5 has a non-joining end part 5a that is not joined to the adhesive surfaces 4a. In addition, a portion where the non-joining end part 5a and the flap region 2a overlap with each other is present.

In a case where a portion where the non-joining end part 5a and the flap region 2a overlap with each other is present, and the flap region 2a has a lower stiffness than the region 3a where the absorbent body is present, the flap region 2a is easily turned up and the release paper 5 is easily peeled off. In addition, in a case where the flap region 2a has a higher light transmittance than the region 3a where the absorbent body is present, the release paper 5 is easily visually recognized from the top sheet side and the release paper 5 is easily peeled off.

Moreover, when the stiffness of the release paper 5 is less than the stiffness of the region 3a where the absorbent body is present, the region 3a is less likely to be folded, as compared with the opposite case, which thus makes it easy to prevent the adhesive surfaces 4a from being adhered to each other when the release paper 5 is peeled off.

In the example shown in FIGS. 15 and 16, the non-joining end part 5a is present in both the product longitudinal direction and the product transverse direction in the plan view. In a case where the non-joining end part 5a is present in both the product longitudinal direction and the product transverse direction, the user can turn the release paper 5 up from the non-joining end part 5a that is present in both the product longitudinal direction and the product transverse direction, making it possible to reduce stress when the release paper 5 is peeled off.

The non-joining end part 5a may have different lengths in the product longitudinal direction and in the product transverse direction.

In a case where the lengths of the non-joining end part 5a in the product longitudinal direction and the product transverse direction are different, it is easier to provide the adhesive surfaces 4a at the product end part while increasing the area of the non-joining end part 5a. Therefore, for example, it is easier for the release paper 5 to be peeled off in a product oblique direction, making it easy to prevent the attachment position from being displaced. In a case where the lengths of the non-joining end part 5a in the product longitudinal direction and the product transverse direction are different, when the release paper 5 has a mark indicating a peel-off in the product oblique direction, it is easy for a user to guide the release paper 5 to peel off in the product oblique direction, making it easy to prevent the attachment position from being displaced.

In the examples shown in FIGS. 15 and 16, the release paper 5 is composed of a single sheet. In a case where the release paper 5 is composed of the single sheet, the release paper 5 is easily peeled off in one step during the peel-off. In addition, it is easier for the release paper 5 to be peeled off in the product oblique direction, which makes it easy to prevent the attachment position from being displaced.

On the other hand, in a case where there are a plurality of adhesive surfaces 4a, as in the example shown in FIG. 17, a configuration in which a plurality of release papers 5 each covering the adhesive surfaces may be provided. The configuration in which the plurality of release papers 5 each covering the adhesive surfaces are provided makes it possible to reduce the amount of dust generated when the pet sheet is attached, the size of the release paper is decreased, as compared with a case of a single sheet. Thus, a risk that the pet sheet is folded during peeling is reduced, making it easy to prevent the self-adhesion between the adhesive surfaces 4a.

In one or more embodiments, in a configuration, the adhesive surfaces 4a may be arranged at four corners of the back sheet 4 and the plurality of release papers 5 each covering the adhesive surfaces 4a may be provided.

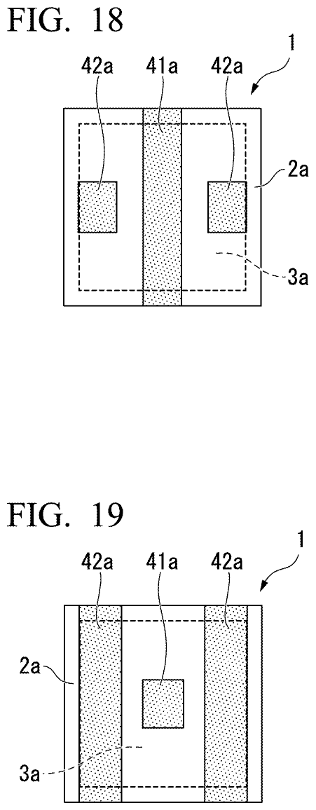

FIG. 18 is a plan view showing an arrangement example of the adhesive surfaces in the pet sheet according to one or more embodiments.

In the example shown in FIG. 18, the adhesive surfaces 4a are present in the product central part and in the product end part in the plan view. Here, the “product central part” refers to a divided region arranged in the center of nine divided regions made by intersection of lines that divide a region where the absorbent body is present into three equal segments in the product length direction and lines that divide the region into three equal segments in the product width direction in the plan view. In addition, the “product side part” means any of eight regions excluding the divided region arranged in the center of nine divided regions made by intersection of lines that divide a region where the absorbent body is present into three equal segments in the product length direction and lines that divide the region into three equal segments in the product width direction in the plan view.

The length of an adhesive surface 41a present in the product central part in the product width direction is longer than the length of an adhesive surface 42a present in the product side part in the product width direction. Therefore, in a case where the release paper 5 is provided, the non-joining end part 5a is provided at the four product corner parts, making it easy to pull the release paper 5 in the product oblique direction, making it possible to prevent the self-adhesion between the adhesive surfaces.

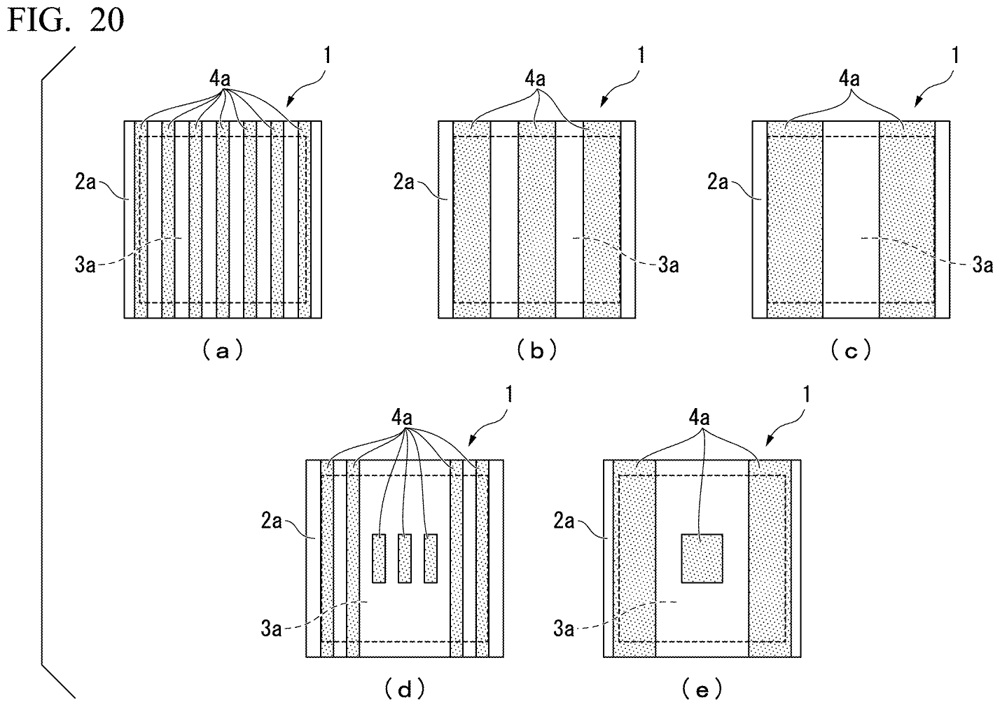

FIG. 19 is a plan view showing an arrangement example of the adhesive surfaces in the pet sheet according to one or more embodiments.

In the example shown in FIG. 19, the adhesive surfaces 4a are present in the product central part and in the product side part in the plan view. The length of the adhesive surface 41a present in the product central part in the product width direction is shorter than the length of the adhesive surface 42a present in the product side part in the product width direction. Accordingly, after the pet sheet is attached, the four corners of the pet sheet are joined, making it less likely to be displaced.

FIG. 20 is a plan view showing an arrangement example of the adhesive surfaces in the pet sheet according to one or more embodiments.

In the example shown in FIG. 20, the direction in which the adhesive surface 4a extends and the direction in which the non-joining end part 5a extends are the same. In addition, the 4a adhesive surfaces are intermittently arranged in a direction orthogonal to the direction in which the non-joining end part 5a extends. Therefore, when the release paper 5 is peeled off, a region which is not joined to the adhesive surfaces 4a at both end parts of the release paper 5 is formed, and the release paper 5 is easily turned up, making it less likely to cause the self-adhesion of the adhesive surfaces 4a.

The adhesive surface 4a may be joined to a product end part that intersects a direction in which the adhesive surface 4a extends. Therefore, the non-joining end part 5a extends in one direction, making it easy for the user to turn the release paper 5 up in one direction.

### (Method of Producing Pet Sheet)

The pet sheet according to one or more embodiments can be produced, for example, as follows.

### (1) Production of Top Sheet

Fibers (for example, core-and-sheath type composite fibers having a PET (core part)/PE (sheath part)) containing a white pigment (for example, titanium oxide) at a predetermined content is supplied to a carding device, and the core-and-sheath type composite fibers are spread in the carding device to form a web. While the formed web is transported further downstream in the transport direction, the web is transported to, for example, an air-through type heating device, in which fibers in the web are entangled with each other, thereby obtaining a hydrophilic non-woven fabric that serves as a top sheet.

### (2) Production of Absorbent Body

A substantially flat absorbent core including the above-described absorbent material is prepared. Further, the above-described upper sheet is attached to the upper surface of the absorbent core, and then the upper sheet and the absorbent core are covered with any core-wrapping sheet, thereby obtaining an absorbent body.

### (3) Production of Animal Excrement Disposal Sheet

The animal excrement disposal sheet of one or more embodiments can be obtained by joining the second surface of the above-described top sheet to one surface of the absorbent body on the upper sheet side using, for example, a hot-melt-type adhesive, then arranging an air-impermeable sheet made of polyethylene as a back sheet on the other surface of the absorbent body on the second absorbent core side, and joining the peripheral edge parts of each of the top sheet and the back sheet with a hot-melt-type adhesive in a state where the absorbent body is interposed between the top sheet and the back sheet.

The pet sheet of the present invention is not limited to the above-described embodiments and the following examples, and may be appropriately combined or modified without departing from the scope and spirit of the present invention. For example, in yet other embodiments of the present invention, the pet sheet may include an intermediate sheet having a liquid diffusibility in the product length direction L and/or in the product width direction W, between the top sheet and the absorbent body, between the absorbent body and the back sheet, or the both. In a case where the pet sheet is provided with such an intermediate sheet, excrement can be absorbed into the absorbent body while diffusing the excrement in the product length direction L and/or in the product width direction W by the intermediate sheet, making it possible to exhibit high absorption performance such as excellent absorption efficiency and difficulty in causing liquid return.

Furthermore, in the present specification, ordinal numbers such as “first” and “second” are to distinguish matters to which the ordinal numbers are attached, and do not mean orders, priority, importance, and the like of each matter.

### <Kit>

A kit according to one or more embodiments includes the pet sheet, and an animal excrement disposal sheet provided with a liquid-permeable top sheet, a liquid-impermeable back sheet, and an absorbent body arranged between these sheets.

According to the kit of one or more embodiments, an owner can hide a urine trace only by overlaying the sheet on a urine trace on the animal excrement disposal sheet by adhesion of the back sheet, which makes it possible to reliably hide the urine trace. In addition, by setting the light transmittance to 60% or less, the pet is less likely to visually recognize the urine trace when the overlay sheet is viewed. Therefore, the pet can correctly ride over the overlay sheet during excrement and is less likely to avoid a site where the urine trace is present, which makes it less likely to leak the urine outside the overlay sheet or to get the pet's feet wet.

In the kit according to one or more embodiments, a color of a region where the absorbent body of the pet sheet is present and a color of a region where the absorbent body of the animal excrement disposal sheet is present may be of the same color system in a plan view. Here, the “same color system” only needs to satisfy that a user can determine that the color of the region where the absorbent body of the pet sheet is present and the color of the region where the absorbent body of the animal excrement disposal sheet is present are the same color. Specifically, it means that the regions have a color difference measured using a color difference meter CR-300 (manufactured by Konica Minolta, Inc.) or a meter equivalent thereto of less than 13, or a difference in the color chart of 24 colors classified by the Ostwald hue ring of 1 or less.

In a case where the color of the region where the absorbent body of the pet sheet is present and the color of the region where the absorbent body of the animal excrement disposal sheet is present are of the same color system, it becomes less likely to feel a discomfort that the owner overlays something on the animal excrement disposal sheet to hide a urine trace when the pet sheet is overlaid on the animal excrement disposal sheet. In addition, before the pet rides over the overlay sheet, the pet is less likely to feel a discomfort to the extent that the pet feels the overlay sheet as a new animal excrement disposal sheet, making it less likely for the pet to avoid the overlay sheet.

In the kit according to one or more embodiments, the colors of the pet sheet and the animal excrement disposal sheet are not particularly limited, and examples thereof include blue, green, gray, and white. Here, blue represents 13 to 19 of the Ostwald hue ring, and green represents 19 to 24 of the Ostwald hue ring.

In the kit according to one or more embodiments, a maximum length L2 of the pet sheet may be greater than a maximum length L1 in a longitudinal or transverse direction when 30 cc of artificial urine is dropped on the animal excrement disposal sheet.

In a case where L2 is greater than L1, even when the frequency of replacing the animal excrement disposal sheet is small, the owner can easily hide a urine trace only by overlaying the pet sheet on the urine trace, making it easy to hide the urine trace more reliably.

Furthermore, the artificial urine is not particularly limited as long as it is used for evaluating absorbent articles, and may be, for example, an aqueous solution including 0.780 mass % of sodium chloride, 0.022 mass % of calcium chloride, 0.038 mass % of magnesium sulfate, and 0.002 mass % of blue No. 1, and ion exchange water.

### <Animal Excrement Disposal Sheet>

The animal excrement disposal sheet according to one or more embodiments is used for overlaying a pet sheet at an excrement site thereon in use.

The animal excrement disposal sheet according to one or more embodiments includes a liquid-permeable top sheet, a liquid-impermeable back sheet, and an absorbent body arranged between these sheets, in which a maximum length L2 of the pet sheet is greater than a maximum length L1 in a longitudinal or transverse direction when 30 cc of artificial urine is dropped on the animal excrement disposal sheet.

In a case where L2 is greater than L1, even when the frequency of replacing the animal excrement disposal sheet is small, an owner can hide a urine trace only by overlaying the pet sheet on the urine trace.

### EXAMPLES

Hereinafter, one or more embodiments will be described in more detail with reference to Examples, but is not limited to these Examples.

### (Production of Pet Sheet)

A top sheet, an absorbent body, and a back sheet were joined by a well-known method to obtain a pet sheet used in each Test Example.

### Test Example 1: Evaluation of Light Transmittance

Standard calibration was performed in accordance with the provisions of HAZE Meter NDH 7000SP II (NIPPON DENSHOKU INDUSTRIES Co., Ltd.), sample sheets shown in Table 1 (30 mm×30 mm) were set, and a light transmittance (%) was measured. The results are shown in Table 1.

In addition, each sample was visually observed and the urine trace visibility was evaluated in accordance with the following criteria. The results are shown in Table 1.
A: The urine trace is not visible.
B: The urine trace is slightly visible.
C: The urine trace is visible.

In addition, each sample was attached to an animal excrement disposal sheet to obtain an overlay sheet. The excrement behavior of a dog was observed using the obtained overlay sheet, and the visual discomfort was evaluated in accordance with the following criteria. The results are shown in Table 1.
A: The dog excreted on the overlay sheets.
B: The dog avoided the overlay sheet and excreted in a different area of the pet sheet.
C: The dog avoided the overlay sheet and excreted outside the pet sheet.

TABLE 1

| | Type of | T.T | Urine trace | Evaluation of |
|---|---|---|---|---|
| | sheet | (%) | visibility | discomfort |
| Test Example 1-1 | (1) | 10.7 | A | A |
| Test Example 1-2 | (1) | 26.5 | A | A |
| Test Example 1-3 | T/S, B/S | 38.4 | B | B |
| Test Example 1-4 | T/S, B/S | 57.1 | B | B |
| Test Example 1-5 | T/S, B/S | 63.9 | C | C |

In Table 1, each abbreviation has the following meaning.

Tt: Total light transmittance (%): Transmittance that includes both a parallel component (PT) and a diffuse component (Dif) of light that passes through a test piece.
(1): A sample having a top sheet, an absorbent body, and a back sheet (the same applies to the following tables).
T/S: A sample having only a top sheet (the same applies to the following tables).
B/S: A sample having only a back sheet (the same applies to the following tables).
T/S, B/S: A sample having only a top sheet and a back sheet (the same applies to the following tables).

### Test Example 2: Evaluation of Thickness of Product

In a plan view of each sample shown in Table 2, the thickness was measured using PEACOCK Thickness Gauge J-B 0.05 mm (manufactured by OZAKI MFG.CO., LTD.) in each of the central parts of nine divided regions made by intersection of lines that divide the region 3a into three equal segments in the product length direction L and lines that divide the region 3a into three equal segments in the product width direction W, and an average value of the thicknesses of the nine points was used as the product thickness. The results are shown in Table 2.

In addition, the urine trace visibility was evaluated in the same manner as in Test Example 1. The results are shown in Table 2.

Furthermore, the visual discomfort was evaluated in the same manner as in Test Example 1. The results are shown in Table 2.

TABLE 2

| | | Thickness | Urine | |
|---|---|---|---|---|
| | Type of | of product | trace | Evaluation of |
| | sheet | (mm) | visibility | discomfort |
| Test Example 2-1 | (1) | 1.9 | A | A |
| Test Example 2-2 | (1) | 15.6 | A | C |
| Test Example 2-3 | (1) | 8.1 | A | B |
| Test Example 2-4 | T/S, B/S | 0.2 | B | A |
| Test Example 2-5 | B/S | 0.05 | C | A |

### Test Example 3: Evaluation of Area Ratio of Absorbent Body

From the size of each sample and the size of the absorbent body, the area proportion (%) of a region where the absorbent body was present to the entire surface of each sample in a plan view of each sample was calculated. The results are shown in Table 3.

In addition, a positional deviation when each sample was reattached after being once attached to the animal excrement disposal sheet was confirmed, and the ease of gripping of the flap part was evaluated in accordance with the following criteria. The results are shown in Table 3.
A: No positional deviation occurred when the sample was reattached.
B: A slight positional deviation occurred when the sample was reattached.
C: A positional deviation occurred when the sample was reattached.

TABLE 3

| | | | Area of | Aera proportion | |
|---|---|---|---|---|---|
| | | Area of | absorbent | of absorbent | Ease of |
| | Type of | product | body | body | gripping of |
| | sheet | (mm²) | (mm²) | (%) | flap part |
| Test Example 3-1 | (1) | 22,500 | 10,000 | 44 | A |
| Test Example 3-2 | (1) | 80,253 | 57,230 | 71 | B |
| Test Example 3-3 | (1) | 144,625 | 105,300 | 73 | B |
| Test Example 3-4 | (1) | 269,225 | 218,000 | 81 | C |

### Test Example 4: Evaluation of Difference Between Thickness of Region where Absorbent Body is Present and Thickness of Region where Absorbent Body is not Present

For each sample shown in Table 4, a difference between the thickness of the region where the absorbent body was present and the thickness of the region where the absorbent body was not present was evaluated. The thickness of the region where the absorbent body was present was measured in the same manner as in Test Example 2. The thickness of the region (flap part) where the absorbent body was not present was measured in the same manner as in Test Example 2, except that any point on the flap part was measured. The results are shown in Table 4.

In addition, each sample was visually observed and the visibility of the flap part was evaluated in accordance with the following criteria. The results are shown in Table 4.
A: The flap part is visible.
C: The flap part is not visible.

In addition, for each sample, the visual discomfort was evaluated in the same manner as in Test Example 2. The results are shown in Table 4.

TABLE 4

| | | Difference | Flap part | |
|---|---|---|---|---|
| | Type of | between | visibility | Evaluation of |
| | sheet | thicknesses | (mm) | discomfort |
| Test Example 4-1 | (1) | 1.7 | A | A |
| Test Example 4-2 | (1) | 4.1 | A | C |
| Test Example 4-3 | (1) | 2.2 | A | B |
| Test Example 4-4 | (1) | 0.7 | C | A |

### Test Example 5: Evaluation of Size of Product

For each sample shown in Table 5, the size of a product was measured. The results are shown in Table 5.

In addition, for each sample, the ease of attachment and ease of detachment to the animal excrement disposal sheet were evaluated in accordance with the following criteria. The results are shown in Table 5.
A: Smoothly attachable to and detachable from the animal excrement disposal sheet.
B: Somewhat difficult to attach to and detach from the animal excrement disposal sheet.
C: Difficult to smoothly attach to and detach from the animal excrement disposal sheet.

TABLE 5

| | | Area of | Ease of |
|---|---|---|---|
| | Type of | product | attachment · Ease |
| | sheet | (cm²) | of detachment |
| Test Example 5-1 | (1) | 225 | A |
| Test Example 5-2 | (1) | 802.53 | B |
| Test Example 5-3 | (1) | 1446.25 | B |
| Test Example 5-4 | (1) | 2692.25 | C |

### Test Example 6: Evaluation by KES Compression Characteristic Tester

The center of each sample (30 mm×30 mm) shown in Table 6 was gently pinched with disks positioned above and below, and a compression area (area of the disk) of 2.0 cm² and a thickness dimension TO of each sample under a load of 0.49 hPa were measured. Next, the measurement sample was compressed to a load of 49.03 hPa at a pressurization rate of 0.02 mm/sec, and a thickness dimension Tm under the load of 49.03 hPa was measured. In addition, a workload (N·m/m²) required during compression from the thickness dimension T0 to the thickness dimension Tm was set as WC, a workload required during restoration from the thickness dimension Tm to the thickness dimension T0 was set as WC2, and a compression recovery rate RC (%) was determined based on a calculation expression below. The results are shown in Table 6.

RC(%)=WC2/WC×100

Moreover, each sample was attached to the urine trace on the animal excrement disposal sheet, each sample was pressed with a finger, and the urine tactile feeling was evaluated in accordance with the following criteria. The results are shown in Table 6.
A: There was no feeling of urine.
B: There was a slight feeling of urine.
C: There was a feeling of urine.

In addition, each sample was attached to an animal excrement disposal sheet to obtain an overlay sheet. The excrement behavior of a dog was observed using the obtained overlay sheets, and the tactile discomfort was evaluated in accordance with the following criteria. The results are shown in Table 6.
A: The dog excreted on the overlay sheets.
B: The dog rode over the overlay sheet to excrete, but made gestures such as changing the posture.
C: After riding over the overlay sheet, the dog avoided the sheet and excreted over another site in the pet sheet.

TABLE 6

| | | Compression | Evaluation of | Evaluation |
|---|---|---|---|---|
| | Type of | workload WC | urine tactile | of |
| | sheet | (gfcm/cm²) | feeling | discomfort |
| Test Example 6-1 | (1) | 0.20 | A | A |
| Test Example 6-2 | (1) | 0.37 | A | C |
| Test Example 6-3 | (1) | 0.31 | A | B |
| Test Example 6-4 | (1) | 0.05 | B | A |
| Test Example 6-5 | T/S | 0.03 | C | A |

### Test Example 7: Evaluation of Qmax Value

For each of samples of Test Examples, the absorbent core or non-absorbent core region was placed on a Thermocool (constant-temperature stand) set at 20° C. and left for a while, a sensor part of T-Box which has been heated to 30° C. is then placed so that the sample and the sensor part face each other to be in contact, and the Qmax value was measured. The results are shown in Table 7. Furthermore, in Table 7, “Tissue” is a sample having only the core wrap.

In addition, each sample was attached to a urine trace on the animal excrement disposal sheet, each sample was touched with a finger, and the contact cooling feeling was evaluated in accordance with the following criteria. The results are shown in Table 7.
A: There was no cooling feeling.
B: There was a slight cooling feeling.
C: There was a cooling feeling.

TABLE 7

| | | | Evaluation of |
|---|---|---|---|
| | Type of | Qmax value | contact cooling |
| | sheet | (W/cm²) | feeling |
| Test Example 7-1 | (1) | 0.035 | A |
| Test Example 7-2 | Tissue | 0.276 | B |
| Test Example 7-3 | B/S | 0.913 | B |
| Test Example 7-4 | B/S | 1.003 | C |

### Test Example 8: Evaluation of Stiffness of Region where Absorbent Body is Present

For each sample shown in Table 8, the stiffness (mN) of the region where the absorbent body 3 was present was measured by the above-described procedure. The results are shown in Table 8.

In addition, for each sample, the urine tactile feeling was evaluated in the same manner as in Test Example 6. The results are shown in Table 8.

In addition, for each sample, the discomfort on touch was evaluated in the same manner as in Test Example 6. The results are shown in Table 8.

TABLE 8

| | | | Evaluation of | |
|---|---|---|---|---|
| | Type of | Stiffness | urine tactile | Evaluation of |
| | sheet | (mN) | feeling | discomfort |
| Test Example 8-1 | (1) | 1.15 | A | A |
| Test Example 8-2 | (1) | 2.71 | A | C |
| Test Example 8-3 | (1) | 1.87 | A | B |
| Test Example 8-4 | (1) | 0.11 | C | A |
| Test Example 8-5 | (1) | 0.52 | B | A |

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1: Pet sheet
2: Top sheet
2a: Flap part
3: Absorbent body
31: Upper sheet
32: Absorbent core
33: Core-wrapping sheet
3a: Region where top sheet, back sheet, and absorbent body are present
4: Back sheet
4a: Adhesive surface
5: Release paper
5a: Non-joining end part

What is claimed is:

1. A pet sheet comprising:
a liquid-permeable top sheet;
a liquid-impermeable back sheet; and
an absorbent body disposed between the liquid-permeable top sheet and the liquid-impermeable back sheet, wherein
the liquid-impermeable back sheet has an adhesive surface,
the liquid-permeable top sheet, the liquid-impermeable back sheet, and the absorbent body are disposed such that a light transmittance of the pet sheet is 60% or less, and
the pet sheet is configured to be overlaid on an animal excrement disposal sheet.

2. The pet sheet according to claim 1, wherein the liquid-permeable top sheet, the liquid-impermeable back sheet, and the absorbent body are disposed such that a thickness of the pet sheet is greater than 0.2 mm and less than or equal to 10 mm.

3. The pet sheet according to claim 1, wherein the liquid-permeable top sheet, the liquid-impermeable back sheet, and the absorbent body are disposed such that an area of a region where the absorbent body is present is 80% or less of an entirety of a surface of the pet sheet in a plan view.

4. The pet sheet according to claim 1, wherein the liquid-impermeable back sheet and the absorbent body are disposed such that a difference between a thickness of a region where the absorbent body is present and a thickness of a flap region where the absorbent body is not present is greater than or equal to 0.3 mm and less than or equal to 5 mm.

5. The pet sheet according to claim 1, wherein a size of the pet sheet is 1,500 cm² or less.

6. The pet sheet according to claim 1, wherein a WC value obtained by a KES compression characteristic tester is between 0.03 and 0.35, inclusive.

7. The pet sheet according to claim 1, wherein a Qmax value is 1.0 W/cm² or less.

8. The pet sheet according to claim 1, wherein the liquid-impermeable back sheet is an air-permeable sheet.

9. The pet sheet according to claim 1, wherein the liquid-permeable top sheet, the liquid-impermeable back sheet, and the absorbent body are disposed such that a stiffness of a region where the absorbent body is present is 0.1 to 3.0 mN, inclusive.

10. The pet sheet according to claim 1, wherein the pet sheet does not have a fold line.

11. The pet sheet according to claim 1, wherein the adhesive surface is disposed in a flap region where the absorbent body is not present in a plan view.

12. The pet sheet according to claim 1, wherein the adhesive surface is not disposed in a flap region where the absorbent body is not present in a plan view.

13. The pet sheet according to claim 1, wherein
the pet sheet has a flap region where the absorbent body is not present in a plan view, and
a light transmittance of the flap region is higher than a light transmittance of a region where the absorbent body is present in the plan view.

14. The pet sheet according to claim 13, wherein the light transmittance of the flap region is 38.4% or more.

15. The pet sheet according to claim 13, wherein a portion where the liquid-permeable top sheet does not overlap the liquid-impermeable back sheet in the plan view is present in the flap region.

16. The pet sheet according to claim 1, wherein in a length direction of the pet sheet or a width direction of the pet sheet, a total length of non-adhesive surfaces is longer than a total length of adhesive surfaces in a plan view.

17. The pet sheet according to claim 1, wherein in both a length direction of the pet sheet and a width direction of the pet sheet, a total length of non-adhesive surfaces is longer than a total length of adhesive surfaces in the plan view.

18. The pet sheet according to claim 1, wherein the adhesive surface is not disposed in a divided region in a center of nine divided regions made by an intersection of lines that divide a region where the absorbent body is present into three equal segments in a length direction of the pet sheet and lines that divide the region into three equal segments in a width direction of the pet sheet in a plan view.

19. The pet sheet according to claim 1, further comprising:
a release paper that covers the adhesive surface, wherein
the release paper has:
a non-joining end part that is not joined to the adhesive surface; and
a flap region where the absorbent body is not present in a plan view, and a portion where the non-joining end part overlaps the flap region in the plan view is present.

20. The pet sheet according to claim 19, wherein a stiffness of the release paper is greater than a stiffness of the flap region.

21. The pet sheet according to claim 20, wherein the stiffness of the release paper is less than a stiffness of a region where the absorbent body is present.

22. The pet sheet according to claim 1, further comprising:
a release paper that covers the adhesive surface, wherein
the release paper has a non-joining end part that is not joined to the adhesive surface, and
the non-joining end part is disposed in both a longitudinal direction of the pet sheet and a transverse direction of the pet sheet in a plan view.

23. The pet sheet according to claim 22, wherein the non-joining end part has different lengths in the longitudinal direction and in the transverse direction.

24. The pet sheet according to claim 22, wherein the release paper has a mark indicating a peel-off in an oblique direction of the pet sheet.

25. The pet sheet according to claim 22, wherein the release paper is composed of a single sheet.

26. The pet sheet according to claim 19, further comprising:
release papers each covering adhesive surfaces.

27. The pet sheet according to claim 26, wherein
the adhesive surfaces are disposed at four corners of the liquid-impermeable back sheet.

28. The pet sheet according to claim 19, wherein
adhesive surfaces are disposed in a central part of the pet sheet and a side part of the pet sheet in the plan view, and
a length of an adhesive surface of the adhesive surfaces in the central part in width direction of the pet sheet is longer than a length of an adhesive surface of the adhesive surfaces in the side part in the width direction.

29. The pet sheet according to claim 19, wherein
adhesive surfaces are disposed in a central part of the pet sheet and a side part of the pet sheet in the plan view, and
a length of an adhesive surface of the adhesive surfaces in the central part in a width direction of the pet sheet is shorter than a length of an adhesive surface of the adhesive surfaces in the side part in the width direction.

30. The pet sheet according to claim 19, wherein
a direction in which the adhesive surface extends is the same as a direction in which the non-joining end part extends, and
adhesive surfaces are intermittently disposed in a direction orthogonal to the direction in which the non-joining end part extends.

31. The pet sheet according to claim 30, wherein an end part of the pet sheet that intersects the direction in which the adhesive surface extends is joined to the adhesive surface.

32. A kit comprising:
the pet sheet according to claim 1; and
an animal excrement disposal sheet including an additional liquid-permeable top sheet, an additional liquid-impermeable back sheet, and an additional absorbent body disposed between the additional liquid-permeable top sheet and the additional liquid-impermeable back sheet.

33. The kit according to claim 32, wherein a color of a region where the absorbent body of the pet sheet is present and a color of a region where the additional absorbent body of the animal excrement disposal sheet is present are of the same color system in a plan view.

34. The kit according to claim 32, wherein a maximum length of the pet sheet becomes greater than a maximum length in a longitudinal or transverse direction when 30 cc of artificial urine is dropped on the animal excrement disposal sheet.

35. An animal excrement disposal sheet comprising:
a liquid-permeable top sheet;
a liquid-impermeable back sheet; and
an absorbent body disposed between the liquid-permeable top sheet and the liquid-impermeable back sheet, wherein
a maximum length of a pet sheet becomes greater than a maximum length in a longitudinal or transverse direction when 30 cc of artificial urine is dropped on the animal excrement disposal sheet, and
the animal excrement disposal sheet is configured to overlay the pet sheet at an excretion site.

36. A use of a pet sheet, comprising:
attaching a pet sheet, having a light transmittance of 60% or more and having one side between 13 to 17 cm, inclusive, to an animal excrement disposal sheet, wherein
in the animal excrement disposal sheet, a maximum length in a longitudinal or transverse direction when 30 cc of artificial urine is dropped on the animal excrement disposal sheet is less than 17 cm.

37. A use of an animal excrement disposal sheet, comprising:
reusing an animal excrement disposal sheet by covering a urine trace on the animal excrement disposal sheet with a pet sheet having a light transmittance of 60% or more and having one side between 13 to 17 cm, inclusive, wherein
a maximum length of the pet sheet becomes greater than a maximum length in a longitudinal or transverse direction when 30 cc of artificial urine is dropped on the animal excrement disposal sheet.
